(19) United States
(12) Patent Application Publication
(10) Pub. No.: US 2005/0261423 A1
(43) Pub. Date: Nov. 24, 2005

(54) Process and apparatus for preparing polymer dispersions

(76) Inventors: Steffen Funkhauser, Viernheim (DE); Frauke Richter, Limburgerhof (DE); Walter Kastenhuber, Mannheim (DE); Andreas Lappe, Niederkirchen (DE); Jochen Kessler, Hassloch (DE); Wolfgang Hummer, Birkenheide (DE); Gerald Wildburg, Speyer (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/482,415

(22) PCT Filed: Jul. 11, 2002
(86) PCT No.: PCT/EP02/07748

§ 371 Date: Jan. 12, 2004

(30) Foreign Application Priority Data
Jul. 12, 2001 (DE) 101 34 023.0

(51) Int. Cl. C08K 3/00; B32B 5/02

(52) U.S. Cl. 524/800; 422/131

(57) ABSTRACT

A process for preparing polymer dispersions of at least one of the polymerizable monomers from the groups consisting of alkyl (meth)acrylates, vinyl esters of carboxylic acids having 1-20 carbon atoms, vinylaromatic compounds, nitrites, vinyl halides, vinyl ethers, hydrocarbons having 2-8 carbon atoms, and hydroxyl-containing monomers in emulsion polymerization technology at a polymerization temperature of at least 40° C., in the presence of a free-radical polymerization initiator, which comprises preparing the polymer, which forms to at least 85% by weight from one or more of these monomers. In a first stage, water, as reaction-inert solvent, dispersing assistants where appropriate, seed where appropriate, and a first portion of monomer(s), where appropriate, are introduced. In a second stage, the initiator is added, and in a third stage, the remainder or full amount of monomer(s) are added directly or in emulsion form in the presence of further water and, where appropriate, further dispersing assistant or other auxiliaries.

It is possible for the first and second stages or second and third stages in each case also to be run in one stage while second and third stages can be run through in a gradient procedure, and in all or some stages the reaction mixture present as a dispersion is moved by an external circuit (10) which leads from and back to the polymerization vessel (2) and which comprises one or more extremely low-shear-conveying cylinder or tubular diaphragm pumps (7) and at least one heat exchanger (8), the polymerization temperature being between 40° C. and 120° C.

The invention relates to a process and to an apparatus for preparing polymer dispersions.

As a general rule, emulsion polymerizations are performed by dispersing one or more polymerizable monomers in a liquid which as far as possible is inert in the reaction—usually water, in which soaps or detergents are present as dispersing assistants. Polymerization takes place mostly in the monomer-containing micelles formed, by means of initiator radicals. High molecular masses can be obtained since monomer is able to penetrate continuously into the micelles. The mechanism is normally that of a free-radical polymerization, the reaction products can frequently be processed further directly as dispersions (for example, in the production of paints and adhesives). Known reactants are alkyl (meth)acrylates, vinyl esters of carboxylic acids, vinyl aromatic compounds, nitriles, vinyl halides, vinyl ethers, hydrocarbons having from 2 to 8 carbon atoms and one or two olefinic double bonds (butadiene, isoprene, chloroprene) or hydroxyl-containing monomers. The particle size and particle size distribution may frequently be controlled by using seed (particles) supplied beforehand or generated in situ. Typical process conditions on the industrial scale are reaction times of between 2 and 12 hours at temperatures in the range between 40° C. and 100° C.

DE 23 32 637 A describes an emulsion polymerization wherein butadiene is reacted with comonomers such as styrene, acrylonitrile (AN) or esters of acrylic or methacrylic acid in the presence of customary emulsifying assistants such as higher fatty acids, higher alkyl (acryloyl)sulfonates, adducts of alkylene oxides with long-chain fatty alcohols, and free-radical initiators such as alkali metal persulfates at temperatures of more than 115° C. An advantage over the prior art with temperatures of less than 80° C. is said to be the higher polymerization rate. However, the performance properties of products of this kind prepared at very high temperatures are often adversely affected in respect, for example, of the molecular mass distribution, the particle size distribution, and, associated therewith, for example, the adhesive bonding strength.

Nevertheless, conducting the reaction at relatively high temperatures, i.e., more than 80° C., in particular more than 85° C.—is a measure which is important for industrial plants, since the reaction times can be reduced significantly. Accordingly, an industrial process can be conducted with lower cycle times, thereby saving on capital investment costs for a greater number of plants. An important problem area to be solved in this context is that of heat dissipation, in order for example to prevent instances of local overheating in exothermic reactions, which may often lead to unwanted side reactions, nonuniform molecular mass distributions or particle sizes.

EP-A 0 486 262 discloses the preparation of emulsion copolymers in which energy balance monitoring is used to control the supply of the comonomers and the temperature. For temperature control use is made, inter alia, of an external heat exchanger. No details can be inferred regarding the quality of the products or the construction of the pumps or heat exchangers.

EP 0 608 567 A discloses the use of a Hydrostar pump in the suspension polymerization of VC to homopolymer or copolymers in a tank having a stirrer and an external heat exchanger. The reaction mixture is passed through said pump at an angle of 90°, the interior having a conically shaped hub with a blade which moves in spiral rotation. Stirring energy and circulation energy must be adjusted in a specific relationship to one another. A comparable pump is also used in the solution known from EP 0 526 741 B1.

In a process for preparing emulsion polymers according to DE 44 42 577 A, the energy released in the exothermic reaction is partly dissipated by distillative removal of a water/monomer mixer from a reaction vessel under reduced pressure. Although this procedure does lead to a reduction in the polymerization time, it is still unsuitable for industrial plants, particularly since the breadth of use hardly ensures, for example, its application for low-boiling (co)monomers or those which are gaseous under standard conditions, such as those of the butadiene type, for example.

EP-A-835 518 describes a process for preparing homopolymers and copolymers by the method of free-radically initiated aqueous emulsion polymerization, again using an external heat exchanger for cooling.

WO 99/14496 discloses a tubular diaphragm pump which can be used to convey chemical media.

In the conveying of commercially customary polymer dispersions, the impellers of the pumps used to date have tended to block during the polymerization. The cause of this was the formation of polymer in areas of the impellers characterized by poor flow, where, on stiffening and reinforcing ribs, for example, deposits formed which subsequently led to the failure of the pumps within a very short time. With the configurations used to date, it was insignificant whether the impellers were enclosed by a spiral housing or whether they protruded freely from the pump chamber.

Types of pumps used to date to convey media with a tendency toward coagulation have been rotary piston pumps, unchokeable pumps, disk pumps, eccentric screw pumps, and reciprocating diaphragm pumps, and also screw spindle pumps. Impellers equipped with rounded blades for streamlined conveying have also been used, such as are disclosed, for example, in DE 199 40 399 A1.

The polymer dispersions to be prepared may be very sensitive to shearing and may alter their viscosity within wide ranges during the preparation process. The polymer dispersions may tend to form coagulum, thereby imposing specific requirements on the pump that circulates the reaction mixture. The pump should convey with as little shearing as possible, so that coagulum is not formed. Furthermore, the pump must be resistant to a certain degree of fouling.

It is an object of the present invention to specify an industrially practicable preparation process with a broad field of use which in particular permits short reaction times, accepts a broad spectrum of different monomers, including monomers gaseous under standard conditions, and is at least comparable in performance properties with currently prepared products, and which is not critical in terms of the effort of cleaning the plant components as a result of fouling and soiling with dispersions that tend to form coagulum.

We have found that this object is achieved in accordance with the invention by a process for preparing polymers of at least one of the polymerizable monomers from the groups consisting of alkyl (meth)acrylates, vinyl esters of carboxylic acids, vinylaromatic compounds, nitrites, vinyl halides, vinyl ethers, hydrocarbons having 2-8 carbon atoms and one or two olefinic double bonds, and hydroxyl-containing monomers using a free-radical polymerization initiator. The process of the invention comprises preparing the polymer, which forms to at least 85% by weight from one or more of these monomers, in the stages below, in which
a) in a first stage, water, as reaction-inert solvent, dispersing assistants where appropriate, seed where appropriate, and a first portion of monomer(s), where appropriate, are introduced,
b) in a second stage, initiator, and
c) in a third stage, the remainder or full amount of monomer(s) are added directly or in emulsion form in the presence of further water and, where appropriate, further dispersing assistant or other auxiliaries,
   it being possible for stages a) and b) or b) and c) in each case to be run through in one stage or b) and c) to be run through in a gradient procedure, and in all or some stages the reaction mixture present is moved for cooling by an external circuit which leads from and back to the reaction vessel and which comprises one or more low-shear-conveying cylinder or tubular diaphragm pumps and at least one heat exchanger, the polymerization temperature being between 40° C. and 120° C.

The use of an extremely low-shear-conveying cylinder or tubular diaphragm pump permits gentle conveying of dispersions with a coagulation tendency during the preparation process without premature failure of the conveying unit by accumulation of deposits on moving components and without notable quality losses in the medium to be conveyed. Complete lining of all those parts of the low-shear-conveying cylinder or tubular diaphragm pump that are in media contact reduces or prevents fouling and formation of coagulum in the interior of the conveying device considerably and, as a result of the relatively long service times, reduces the cleaning effort, thereby having a beneficial effect on plant availability. As well as in a cooling circuit assigned to the polymerization vessel, the low-shear-conveying cylinder or tubular diaphragm pump may also be used to convey dispersions with a tendency toward coagulation further in a preparation plant, with no coagulation of the conveyed medium during conveying, owing to the low-shear conveying principle of the cylinder or tubular diaphragm pump. Within the cooling circuit, the cylinder or tubular diaphragm pump may be positioned at different sites: for example, upstream or downstream of the heat exchanger. Owing to its complete lining with a friction-reducing coating, cleaning of the cylinder or tubular diaphragm pump is very easy to carry out. The pulsations which are established may provide for a significant reduction or prevention of wall deposits in the circuit.

Using the extremely low-shear-conveying cylinder or tubular diaphragm pump, it is possible to operate a process for preparing homopolymers or copolymers on the industrial scale wherein the polymer is formed to at least 90% by weight, in particular to at least 93% by weight, from one or more of the monomers mentioned and the polymerization temperature is between 50° C. and 100° C., with particular preference between 60° C. and 95° C. and with very particular preference between 70° C. and 95° C. The process of the invention may be carried out alternatively such that in stage a) or in a combination of a) and b) a portion of monomer(s) is introduced already and later in stage c), which can also be run through in a gradient procedure, or in a combination of b) and c), it being possible for b) and c) to be run through both in a single stage and in a gradient procedure, the remainder is added, or the whole amount is added exclusively in stage c), either in one stage or in a gradient procedure or in a combination of stages b) and c) (in one stage or in a gradient procedure). If introduction of monomer(s) takes place in stage a) or in combination of stages a) and b) already, the amount introduced is appropriately between 3 and 30% by weight of the whole amount of monomer(s) to be supplied, preferably from 5 to 25% by weight and from 8 to 20% by weight. Water-insoluble or sparingly water-soluble monomers are appropriately supplied already in emulsion form, i.e., admixed with water and dispersing assistant.

Examples of principal monomers are alkyl (meth)acrylates such as methyl methacrylate, methyl acrylate, n-butyl acrylate, ethyl acrylate and 2-ethylhexyl acrylate. Furthermore, mixtures of the alkyl (meth)acrylates are also suitable. Also suitable are vinyl esters of carboxylic acids having 1-20 carbon atoms such as, for example, vinyl laurate, vinyl stearate, vinyl propionate, Versatic acid vinyl ester, and vinyl acetate. Suitable vinylaromatic compounds include vinyltoluene, α- and p-methylstyrene, α-butylstyrene, 4-n-butylstyrene, 4-n-decylstyrene and, preferably, styrene. Examples of nitriles are acrylonitrile and methacrylonitrile. Besides these it is also possible to use the vinyl halides chlorine-, fluorine- or bromine-substituted, ethylenically unsaturated compounds, preferably vinyl chloride and vinylidene chloride. Examples of vinyl ethers include vinyl methyl ether or vinyl isobutyl ether. Preference is given to vinyl ethers of alcohols containing from 1 to 4 carbon atoms. Mention should also be made of hydrocarbons having from 2 to 8 carbon atoms and one or two olefinic double bonds.

Principal monomers are the alkyl (meth)acrylates, especially the C₁-C₈ alkyl (meth)acrylates, vinyl aromatic compounds having up to 20 carbon atoms, especially styrene, and mixtures of the above monomers. Further monomers are, for example, hydroxyl-containing monomers, particularly C₁-C₁₀ hydroxyalkyl (meth)acrylates, (meth)acrylamide, ethylenically unsaturated acids, especially carboxylic acids such as (meth)acrylic acid or itaconic acid and the anhydrides thereof, dicarboxylic acids and their anhydrides or monoesters; for example, maleic acid, fumaric acid or maleic anhydride. As hydrocarbons having from 2 to 8 carbon atoms and two olefinic double bonds, mention may be made of butadiene, isoprene, and chloroprene.

In emulsion polymerization, it is normal to use ionic and/or nonionic emulsifiers and/or protective colloids and/or stabilizers as surface-active compounds.

Suitable emulsifiers include anionic, cationic, and nonionic emulsifiers. As accompanying surface-active substances it is preferred to use exclusively emulsifiers, whose molecular weights, unlike those of the protective colloids, are usually less than 2000 g per mole. Where mixtures of surface-active substances are used, the individual components must of course be compatible with one another, which in case of doubt can be checked by means of a few preliminary tests. Surface-active substances used preferably comprise anionic and nonionic emulsifiers. Common accompanying emulsifiers are, for example, ethoxylated fatty alcohols (EO units: 3-50, alkyl radical: C₈-C₃₈), ethoxylated mono-, di- and tri-alkylphenols (EO units: 3-50, alkyl radical: C₄-C₉), alkali metal salts of dialkyl esters of sulfosuccinic acid and also alkali metal and ammonium salts of alkyl sulfates (alkyl radical: C₈-C₁₂), of ethoxylated alkanols (EO units 4-30, alkyl radical: C₁₂-C₁₈), of ethoxylated alkyl phenols (EO units: 3-50, alkyl radical: C₄-C₉), of alkylsulfonic acids (alkyl radical: C₁₂-C₁₈), of alkylaryl sulfonic acids (alkyl radical: C₉-C₁₈), and of sulfonates with ethoxylated fatty alcohols. Further suitable emulsifiers can also be found in Houben-Weyl, Methoden der organischen Chemie, Volume 14/1, Makromolekulare Stoffe, Georg Thieme Verlag, Stuttgart 1961, pages 192 to 208.

The seed is either generated in situ or introduced beforehand. If desired, the addition may be made at different points in time, in order for example to bring about a polydisperse or polymodal distribution, a bimodal distribution for example. The proportions, based on the fraction of monomer(s) as 100% by weight, are frequently from 0.1 to 5.0% by weight, preferably from 0.2 to 3.0% by weight.

Water-soluble initiators for the emulsion polymerization are, for example, ammonium salts and alkali metal salts of peroxodisulfuric acid, sodium peroxodisulfate for example, hydrogen peroxide or organic peroxides, such as tert-butyl hydroperoxide, for example. So-called reduction, oxidation (redox) initiating systems are suitable. The redox initiator systems consist of at least one, usually inorganic, reducing agent and one organic or inorganic oxidizing agent. The oxidizing component comprises, for example, the initiators already mentioned above for the emulsion polymerization.

The reducing component comprises, for example, alkali metal salts of sulfurous acid such as, for example, sodium sulfite, sodium hydrogen sulfite, alkali metal salts of disulfurous acid such as sodium disulfite, bisulfite addition compounds of aliphatic aldehydes and ketones, such as acetone bisulfite or reducing agents such as hydroxymethanesulfinic acid and its salts or ascorbic acid. The redox initiator systems may be used together with soluble metal compounds whose metallic component is able to exist in a plurality of valence states.

Customary redox initiator systems are, for example, ascorbic acid/iron(II) sulfate/sodium peroxodisulfate, tert-butyl hydroperoxide/sodium disulfite, tert-butyl hydroperoxide/Na hydroxymethanesulfinic acid. The individual components, such as the reducing component, for example, may also be mixtures, for example, a mixture of the sodium salt of hydroxymethanesulfinic acid and sodium disulfite. The amount of the initiators is generally from 0.1 to 10% by weight, preferably from 0.2 to 5% by weight, based on all of the monomers to be polymerized. It is also possible to use two or more different initiators in the emulsion polymerization.

During the reaction it is also possible to add up to 5% by weight, based on the fraction of monomer(s) as 100% by weight, of auxiliaries such as molecular weight regulators, further surfactants, acids, salts or complexing agents. If the polymerization is conducted in the presence of from 3 to 10% by weight of a volatile organic blowing agent, then the processes of the invention may also be used to prepare expandable polymers such as expandable polystyrene, for example.

For secondary processing, which is necessary, for example, to increase the stability on storage, alkalis, such as aqueous NaOH solution or bases (NH₃ or suitable amines) for setting a pH of between 4 and 10, may be added to the end product of the emulsion polymerization. Further known additions are preservatives such as microbiocides, film formers or leveling agents, defoamers, or adhesion-increasing resin emulsions.

The emulsion polymerization takes place in general at from 30 to 150° C., preferably from 50 to 95° C. The polymerization medium may consist either of water alone or of mixtures of water and liquids which are miscible with it, such as methanol, for example. Preferably, water alone is used. The emulsion polymerization may be conducted either as a batch process or in the form of a feed process, including staged or gradient procedures. Preference is given to the feed process, wherein a portion of the polymerization batch or else a polymer seed is introduced in an initial charge, this initial charge is heated to the polymerization temperature and partly polymerized, and then the remainder of the polymerization batch is supplied to the polymerization zone continuously in stages or under a concentration gradient, usually by way of two or more spatially separate feed streams, of which one or more comprise the monomers in pure or emulsified form, and during this addition the polymerization is maintained.

The devices used in the external cooling circuit assigned to the polymerization vessel or in line sections which supply dispersions with a tendency toward coagulation to further processing steps are suitable for an industrial process regime. The extremely low-shear-conveying cylinder or tubular diaphragm pump used exerts a particularly low shearing action on the dispersions with a tendency toward coagulation and is resistant to pressures up to 25 bar (or more if needed). The low-shear-conveying unit has an hourly throughput of up to 100 m³/h, preferably 60 m³/h, with particular preference up to 45 m³/h, and must be able to withstand temperatures of more than 100° C.

By connecting a plurality of cylinder or tubular diaphragm pumps in parallel, the maximum conveying quantity can be adapted in the process.

By virtue of the lining of those parts that are in media contact with a friction-reducing coating such as PTFE, for example, the extremely low-shear-conveying cylinder or tubular diaphragm pump employed has a long service life; the service lives are very long owing to the internal lining of the cylinder or tubular diaphragm pump. Furthermore, the cylinder or tubular membrane pump does not have any zones of poor flow, being very simply constructed, so that it can be used over a wide viscosity range even in the case of highly unstable emulsion polymers. The cylinder or tubular diaphragm pump has no dynamic seals. It seals hermetically and so contributes to increasing plant safety. Furthermore, the cylinder or tubular diaphragm pump is self-priming and secure against running dry; there is hardly any use of wearing parts, since the diaphragm is actuated by means of hydraulic force transfer, thereby giving long service lives and giving rise to low repair and maintenance costs.

The heat exchangers may be operated such that either a substantially laminar or else a turbulent flow profile is developed in them; the action of shearing forces should be as low as possible in order to prevent formation of coagulum by dispersions which have a tendency toward coagulation, and in particular no zones from which flow is absent should occur.

The process proposed in accordance with the invention, which can be operated in industrial plants, is especially suitable for preparing aqueous polymer dispersions whose film has a low glass transition temperature (DSC technique); it is especially suitable with glass transition temperatures of <150° C., preferably of <100° C., in particular of <50° C. Moreover, it is also found suitable for polymer dispersions having an average particle size of between 50 and 2000 nm, in particular from 100 to 1500 nm. The polymer dispersion has a viscosity of from 30 to 2000 mPas (measured at 100 s⁻¹); during the polymerization, the viscosity may also be higher or lower.

The invention is described in more detail below with reference to the drawing:

In the drawing

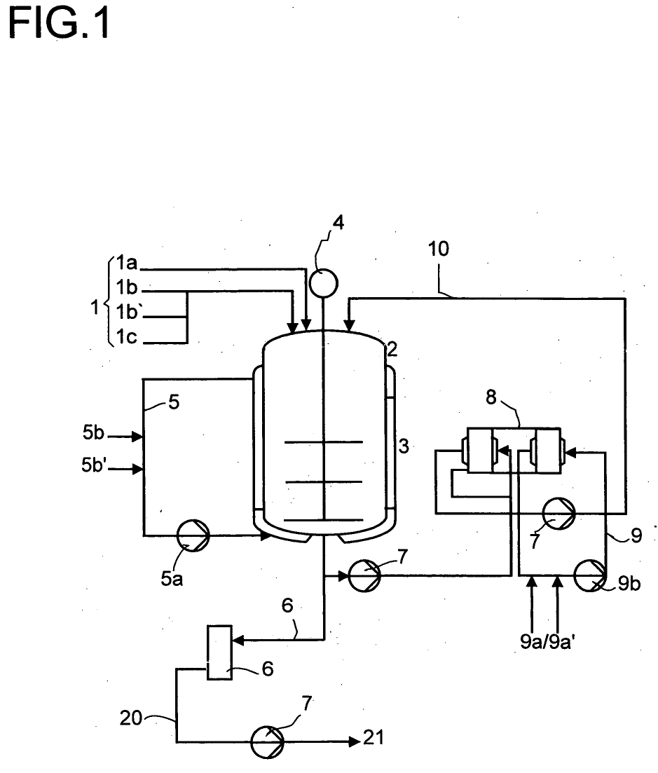

FIG. 1 shows a diagrammatic representation of the plant components required for the process,

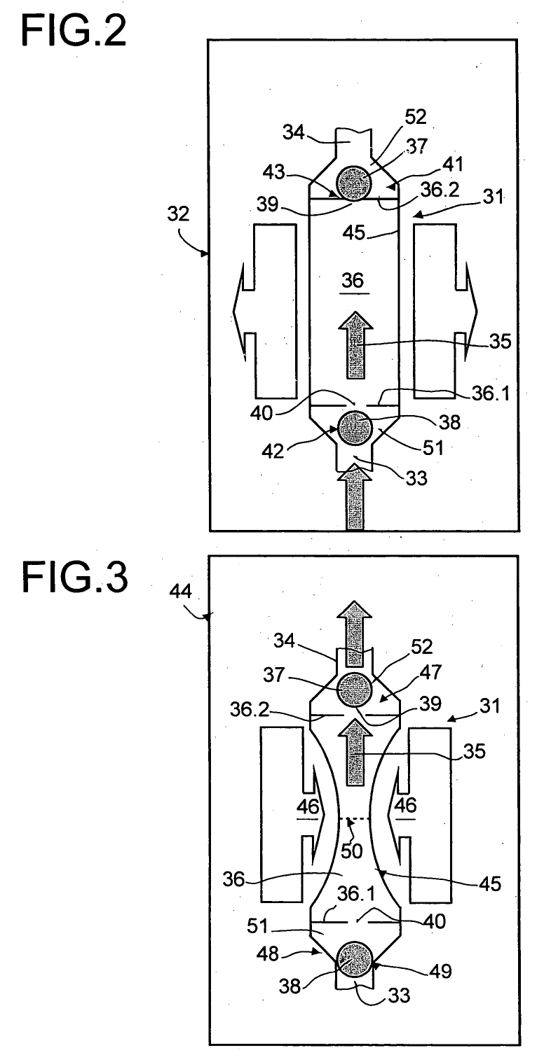

FIG. 2 shows the extremely low-shear-conveying cylinder or tubular diaphragm pump during its priming cycle, and

FIG. 3 shows the cylinder or tubular diaphragm pump during a pumping cycle, and

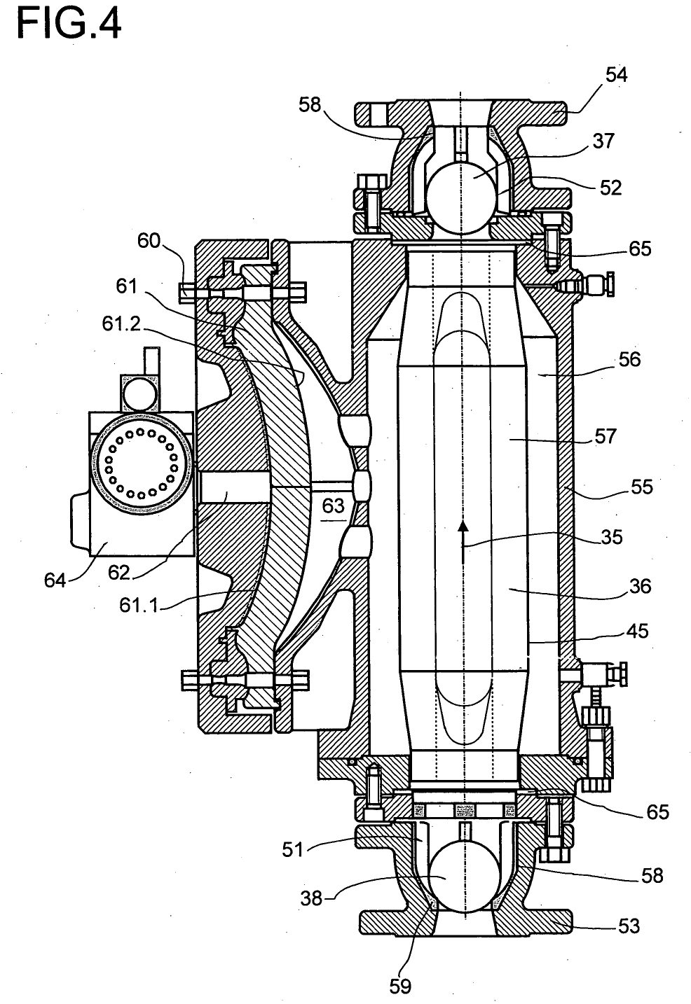

FIG. 4 shows a variant embodiment of the conveying device in a sectioned representation.

From the representation according to FIG. 1 it is evident that the monomer(s) 1b, 1b′, the initiator 1c may be introduced from storage vessels or pipelines 1 into the polymerization vessel 2, designed for up to 15 bar, for example, and equipped with a motor-driven stirrer 4, it being possible for the internal volumes of the polymerization vessel to be from 15 to 100 m³; the introduction of the monomer(s) and initiator may take place with the supply of steam via 1a). The polymerization vessel 2 includes a heating/cooling jacket 3 whose circuit 5 may be fed with cooling water 5b or with steam 5b′ and may be operated by way of a pump 5a. The finished product from the polymerization vessel 2 may be stored temporarily in a storage vessel 6 with steam/nitrogen via a pipeline 6. The extremely low-shear-conveying cylinder or tubular diaphragm pump 7, which may be installed both upstream and downstream of the heat exchanger 8, transports the reaction mixture, which has a tendency toward coagulation, through a pipeline or tubeline to one or more heat exchangers 8, which for cooling are controlled by way of the circuit 9 via a coolant-conveying pump 9b with either cooling water 9a or steam 9a′. The heat exchanger or exchangers 8 may be designed, for example, as plate heat exchangers, in which a turbulent flow profile is established, or else as spiral heat exchangers, in which a substantially laminar flow profile is established. The exchange area of the heat exchangers is of the order of magnitude of approximately 20 m². The external cooling circuit 10 leads via pipelines back into the polymerization vessel 2.

Monitoring and control of the respective heating/cooling circuits 9 and 10, respectively, of the polymerization vessel 2 and of the heat exchanger 8, respectively, takes place appropriately by way of a cascade control. A first temperature measurement takes place usually internally in the polymerization vessel 2, a second in the heating/cooling circuit 3 of the polymerization vessel 2 in combination with that of the reaction mixture in the pipeline after leaving the heat exchanger 8; a third temperature measurement is generally performed in the pipeline after leaving the heat exchanger 8 in combination of the heating/cooling circuit 9 of the heat exchanger 8.

The dispersion which has a tendency toward coagulation that is taken off from the polymerization vessel 2 may be conveyed via a feedline 20, by means of the extremely low-shear-conveying cylinder or tubular diaphragm pump 7, into further vessels 21 or further plant components of the preparation process, such as, for example, plant parts for removing the residual monomers or for secondary processing.

The representation according to FIG. 2 shows a low-shear-conveying unit during the pumping cycle.

During the priming cycle 32 a preferably spherically configured closing element 38 accommodated in an inlet chamber 51 is set back from an inlet aperture 40 located in a first partition 36.1 of a conveying chamber 36 in such a way that medium with a tendency to coagulate which is to be conveyed through the opened inlet aperture 40 enters the conveying chamber 36 in the conveying direction 35. By way of an inlet 33, medium with a tendency to coagulate flows through the inlet chamber 51, with the spherically configured closing element 38 in the open position 42, into the conveying chamber 36. At the same time, a likewise spherically configured closing element 37, accommodated above a second partition 36.2, is moved into its closing position 41 in such a way that the preferably spherically configured closing element 37 sealingly closes an outlet aperture 39 in the second partition 36.2. Accordingly, the medium with a tendency to coagulate that enters the conveying chamber 36 by way of the inlet aperture 40 in the first partition 36.1 flows only into said chamber 36 and is hindered from flowing into an outlet 34. In the condition depicted in FIG. 2, i.e., the priming cycle 32 of the inventively configured conveying device 31, the closing element 37, which is accommodated on the outlet side in an outlet chamber 52, adopts a sealing position on a sealing seat 43 on the second partition 36.2, which bounds the conveying chamber 36 in flow direction 35.

The entry of a volume of the medium having a tendency to coagulate, said volume being that to be conveyed during one pumping cycle 44, is achieved by pressure relief of the deformable walls 45 of the conveying chamber 36. The volume entering the conveying chamber 36 via the inlet aperture 40, with the inlet-side closing element 38 in its open position 42, is dependent on the outward deformation of the deformable walls 45 that is achievable during the priming cycle 32, and is also dependent on the size of the conveying chamber 36.

FIG. 3 shows the cylinder or tubular diaphragm pump during a pumping cycle.

During the pumping cycle, designated by reference symbol 44, of the conveying device 31 constituted in accordance with the invention, the closing element 38 which closes the inlet 33 is moved into a sealing seat 49. In this position, the closing element 38 provided on the inlet side closes ingress into the inlet chamber 51, so that the medium having a tendency to coagulate does not flow into said chamber 51 and in particular does not enter the conveying chamber 36. The inlet chamber 51 communicates with the conveying chamber 36 via the aperture 40 in the first partition 36.1 which bounds the conveying chamber 36. During the pumping cycle, the closing element 37 provided on the outlet side, which closes the outlet aperture 39 on the first partition 36.1 which bounds the conveying chamber 36, is moved out of its closed position 41 in accordance with the representation in FIG. 2 and, in its open position 47, it frees the aperture 39 in the first partition 36.1 which bounds the conveying chamber 36. This ensures that, when the deformable walls 45 are subjected to pressure 46 and the conveying chamber 36 undergoes a contraction movement initiated in this way, the volume of the medium with a tendency to coagulate that is present in said chamber 36 flows in conveying direction 35 through the aperture 39 in the second partition 36.2 into the outlet chamber 52, flows around the closing element 37 present therein, preferably designed in spherical form, and leaves the cylinder or tubular diaphragm pump 7 by way of the outlet 34. The pressurization 46 of the deformable walls 45 of the conveying chamber 36 takes place preferably by way of the compression of a liquid which surrounds the deformable walls 45 of the conveying chamber 36 on the outside thereof. This ensures that a uniform deformation of the walls 45 is produced, so that the volume of the medium with a tendency to coagulate that is accommodated therein and is to be conveyed is conveyed in the direction of the outlet 34 with as little shearing as possible. For each contraction of the conveying chamber 36 of the conveying unit 31, up to ⅓ of the volume of the conveying chamber 36 of fluid system can be conveyed. The deformable walls 45, configured preferably as a cylinder diaphragm or tubular diaphragm, is held hermetically sealed in the housing in the region of the first partition 36.1 and in the region of the second partition 36.2, preferably at the clamp position not shown in FIG. 3, thereby effectively preventing the emergence of medium to be conveyed, with a tendency toward coagulation, from the conveying chamber 36 of the inventively configured conveying device 31. Besides a coating (PTFE) of the deformable walls 45, they may also consist of solid material (PTFE) or another friction-reducing material. In addition to the use of a friction-reducing material, the material used may also comprise a material which is deformable and which permits the contraction and expansion of the walls 45 that requires no coating or special material treatment.

The representation according to FIG. 4 shows in more detail a variant embodiment of the proposed conveying device in a sectioned representation.

The representation according to FIG. 4 shows a conveying device in whose housing 55 there is provided a conveying chamber 36 designed preferably as a cylinder or tubular diaphragm. The deformable walls 45 bound the conveying chamber 36. The deformable walls 45 surrounding the hollow conveying chamber 36 are sealingly clamped at clamp points 65 in the housing 55 of the conveying device. A cavity 56 is formed between the internal wall and the outside of the deformable walls 45 of the conveying chamber 36. Within the cavity 56 there is a volume of an inert liquid such as glycol, for example.

On the inlet side, an inlet flange 53 is fastened on the housing and embraces an inlet chamber 51 containing the inlet-side closing element 38. Provided in the region of the outlet 34 on the housing 55 of the inventively configured conveying device there is an outlet flange 54 which in turn accommodates an outlet chamber 52 in which there is accommodated the closing element 37 provided on the outlet side and preferably of spherical design.

The conveying chamber 36, which extends substantially parallel to the conveying direction 35 for the medium with a tendency to coagulation that is to be conveyed, is constituted as a cylinder diaphragm or tubular diaphragm whose end regions are each sealingly clamped in clamp sites 65 on the housing 55 of the conveying device presented in accordance with the invention. The cavity 56 that surrounds the outer wall of the deformable walls 45 is acted on by a flat diaphragm 61 which is fastened by fixing screws 60 on the housing 55 but is deformable. The flat diaphragm 61 comprises an inner wall 61.1 which can be pressurized via a connection 62 for a pressure medium, a pneumatic drive unit 64 for example. The outer wall 61.2 of the flat diaphragm 61 fixed with fixing screws 60 in the housing 55 forms a movable boundary of a pressure chamber 63. By way of the bores shown by way of example in FIG. 4, the pressure chamber 63 and the inert liquid volume present therein is in communication with the cavity 56 in the housing 55 which surrounds the conveying chamber 36 with deformable walls 45. When the flat diaphragm 61 is acted on via the connection 62 for a pressure medium, triggered by actuation of the pneumatic drive unit 64, the pressure built up in the pressure chamber 63 is transferred to the liquid volume of the inert liquid accommodated in the cavity 56 between the outer wall of the deformable walls 45 and the inside of the housing 55, and imposes a contraction movement on the deformable walls 45 of the conveying chamber 36.

Besides the pressurization of the flat diaphragm 61 by a pneumatic actuating unit 64, as depicted here, the flat diaphragm 61 may of course also be deformed by pressurizing it with a hydraulic fluid, by means of an electrically driven hydraulic actuating unit (not shown here). The common feature of both drive variants is that no mechanical parts subject to wear are used, thereby considerably reducing the service life and the repair and maintenance costs of the conveying device for a medium with a tendency to coagulate.

In a further embodiment, the deformable walls 45 of the conveying device are surrounded by a pressurizable cavity. The cavity is surrounded in turn by the housing wall, so that emergence of fluid if the deformable walls 45 are damaged can be effectively prevented. This takes account of the increasing safety requirements imposed on production plants. Advantageously, the deformable walls 45 are configured as a cylinder or tubular diaphragm. Preference should be given to an oval predeformation of the cylinder or tubular diaphragm pump 7. Other geometries are, however, entirely possible. Accordingly, it is possible in particular to generate pulsating movements which prevent media that are to be conveyed clinging to the inside of the walls 45 of the conveying chamber 36, which are configured as a deformable diaphragm wall. In a preferred embodiment, the parts which contact the media, such as partition walls, for example, may bound the conveying chamber 36 of the conveying device 7 in the flow direction, and also the apertures in the closing elements which open the partition walls, and also the chambers surrounding the closing elements, may be provided with a PTFE coating. Besides a PTFE coating, other friction-reducing materials may also be used to line the aforementioned components of the extremely low-shear-conveying cylinder or tubular diaphragm pump 7 that is proposed in accordance with the invention and is intended for media having a tendency to coagulate. Besides the use of a friction-reducing material, the material used may also be a deformable material which permits the contraction and expansion of the walls 45 and requires no coating or special material treatment.

In an advantageous embodiment, the seat areas of the closing elements closing elements provided in the inlet and outlet region of the low-shear-conveying cylinder or tubular diaphragm pump 7, said elements freely closing and opening an inlet aperture and an outlet aperture, respectively, are of spherical configuration and may be provided with a friction-reducing coating such as PTFE, for example. The closing elements which seal the inlet and outlet, respectively, of the low-shear-conveying cylinder or tubular diaphragm pump 7 for each priming and pumping cycle are accommodated in chambers which may have been provided with a lining which, where appropriate, comprises a friction-reducing material. Preferably, in the cavity within the housing of the low-shear-conveying cylinder or tubular diaphragm pump 7 between the inner wall of the cavity and the outer wall of the deformable walls 45 of the conveying chamber 36, a cavity is formed in which an inert liquid such as glycol, for example, may be accommodated. The inert liquid can be used to generate a uniform contraction or expansion of the deformable walls 45 as viewed in the flow direction. Liquid accommodated in the cavity between the deformable walls 45 and the inside of the housing of the extremely low-shear-conveying cylinder or tubular diaphragm pump is preferably subjected to pressure and relieved from pressure by way of a flat diaphragm pump acted on by means of a drive. The flat diaphragm acts indirectly on the deformable walls 45 of the conveying chamber, by way of the liquid volume accommodated in the cavity, and makes it possible to dispense with mechanical drive components, which considerably lessens the susceptibility to wear of the low-shear-conveying cylinder or tubular diaphragm pump 7 configured in accordance with the invention. Depending on the pressure impressed on the liquid, the contraction of the deformable walls 45 that is necessary during the pumping cycle, and, respectively, during the priming cycle, the necessary expansion for drawing in a conveying volume of the medium with a tendency to coagulate, is established in the conveying chamber 36. The drive may advantageously be configured as a pneumatic drive, thereby making it possible to dispense with mechanical wear components, since the pressurization of the [lacuna] in the cavity between deformable walls 45 of the conveying chamber and inner wall of the housing of the conveying device can be achieved by simple deformation of the flat diaphragm. The flat diaphragm extends substantially parallel to the conveying chamber on the housing and is fixed thereto in fastenings.

Besides the flat diaphragm being pressurizable pneumatically, it may also be pressurized by way of a hydraulic fluid, which likewise makes it possible to dispense with mechanical components that are subject to wear. Accordingly, it is possible to achieve very long service lives of the cylinder or tubular diaphragm pump 7 proposed in accordance with the invention, resulting in long maintenance intervals and very low repair and maintenance costs.

### REFERENCE LIST

1 pipeline
1a steam
1b monomer
1b′ monomer
1c inhibitor
2 polymerization vessel
3 heating/cooling jacket
4 driven stirrer
5 circuit
5b cooling water
5b′ steam
5a conveying pump
6 pipeline
6a storage vessel
7 low-shear-conveying cylinder or tubular diaphragm pump
8 heat exchanger
9 heat exchanger circuit
9b pump
9a cooling water
9a′ steam
10 external cooling circuit polymerization vessel 2
20 feedline
21 further vessel and plant components
31 conveying device
32 priming cycle
33 inlet
34 outlet
35 conveying device
36 conveying chamber
36.1 first partition
36.2 second partition
37 outlet closing element
38 inlet closing element
39 outlet aperture
40 inlet aperture
41 closed position of 37
42 open position of 38
43 sealing seat of 37
44 pumping cycle
45 deformable walls
46 pressurization
47 open position of 37
48 closed position of 38
49 sealing seat of 38
50 narrowest cross section
51 inlet chamber
52 outlet chamber
53 inlet flange
54 outlet flange
55 housing
56 cavity
57 cylinder diaphragm (PTFE)
58 lining
59 seat area (PTFE)
60 fixing screw
61 flat diaphragm
61.1 inner wall
61.2 outer wall
62 connection for pressure medium
63 pressure chamber
64 drive
65 clamp position of deformable walls 45

1. A process for preparing polymer dispersions of at least one of the polymerizable monomers from the groups consisting of alkyl (meth)acrylates, vinyl esters of carboxylic acids having 1-20 carbon atoms, vinylaromatic compounds, nitrites, vinyl halides, vinyl ethers, hydrocarbons having 2-8 carbon atoms and one or two olefinic double bonds, and hydroxyl-containing monomers in emulsion polymerization technology at a polymerization temperature of at least 40° C., in the presence of a free-radical polymerization initiator, which comprises preparing the polymer, which forms to at least 85% by weight from one or more of these monomers, in the stages below, in which
a) in a first stage, water, as reaction-inert solvent, dispersing assistants where appropriate, seed where appropriate, and a first portion of monomer(s), where appropriate, are introduced,
b) in a second stage, the initiator, and
c) in a third stage, the remainder or full amount of monomer(s) are added directly or in emulsion form in the presence of further water and, where appropriate, further dispersing assistant or other auxiliaries,
it being possible for stages a) and b) or b) and c) in each case to be run in one stage or b) and c) to be run through in a gradient procedure, and in all or some stages the reaction mixture present as a dispersion is moved by an external circuit which leads from and back to the polymerization vessel and which comprises one or more extremely low-shear-conveying cylinder or tubular diaphragm pumps and at least one heat exchanger having a substantially laminar flow profile, and the polymerization temperature is between 40° C. and 120° C.

2. A process as claimed in claim 1, wherein the polymer is formed to at least 90% by weight from one or more of the monomers.

3. A process as claimed in claim 1, wherein the polymer is formed to at least 93% by weight from one or more of the monomers.

4. A process as claimed in claim 1, wherein the polymerization temperature is from 50° C. to 100° C.

5. A process as claimed in claim 1, wherein the monomer is at least one of styrene, butadiene, alkyl (meth)acrylate, and (meth)acrylonitrile.

6. A process as claimed in claim 1, wherein the throughput of reaction mixture through the external circuit is from 5 to 200 m³/h in particular from 10 to 100 m³/h.

7. An apparatus for conducting a process for preparing polymer dispersions of at least one of the polymerizable monomers from the groups consisting of alkyl (meth)acrylates, vinyl esters of carboxylic acids having 1-20 carbon atoms, vinylaromatic compounds, nitriles, vinyl halides, vinyl ethers, hydrocarbons having 2-8 carbon atoms and one or two olefinic double bonds, and hydroxyl-containing monomers in emulsion polymerization technology at a polymerization temperature of at least 40° C. in the presence of a free-radical polymerization initiator,
which process comprises preparing the polymer, which forms to at least 85% by weight from one or more of these monomers, in the stages below, in which
a) in a first stage, water, as reaction-inert solvent, dispersing assistants where appropriate, seed where appropriate, and a first portion of monomer(s), where appropriate, are introduced,
b) in a second stage, the initiator, and
c) in a third stage, the remainder or full amount of monomer(s) are added directly or in emulsion form in the presence of further water and, where appropriate, further dispersing assistant or other auxiliaries,
it being possible for stages a) and b) or b) and c) in each case to be run in one stage or b) and c) to be run through in a gradient procedure, and in all or some stages the reaction mixture present as a dispersion is moved by an external circuit which leads from and back to the polymerization vessel and which comprises one or more extremely low-shear-conveying, cylinder or tubular, diaphragm pumps and at least one heat exchanger having a substantially laminar flow profile, and the polymerization temperature is between 40° C. and 120° C.,
wherein said apparatus comprises as structural components,
devices for storing and adding materials used and formed in said process,
a reaction vessel for carrying out said emulsion polymerization, said vessel having a jacket adapted for heating or cooling,
devices for emptying the reaction vessel,
said external cooling circuit,
connecting lines between, from and to structural components of the apparatus,
wherein at least one of the extremely low-shear-conveying, cylinder or tubular, diaphragm pumps comprises:
a conveying chamber adapted for conveying materials used and formed in said process, said chamber being bounded by deformable walls, and wherein parts in contact with said materials are provided with a friction-reducing coating or are composed of a friction-reducing material;
a cavity bounded by the opposite surface of said deformable walls and the inner surface of a housing, and adaptable to accommodate an inert liquid which is pressurizable and relievable from pressure by a flat diaphragm;
said flat diaphragm comprising an inner wall and an outer wall, said flat diaphragm being activatible by means of a drive, said flat diaphragm adapted to be acted upon by a pressure medium on its inner wall, and the outer wall of said flat diaphragm bounding a pressure chamber.

8-11. (canceled)

12. An apparatus as claimed in claim 7, wherein the deformable walls are configured as a cylinder diaphragm or tubular diaphragm with an oval predeformation.

13. An apparatus as claimed in claim 7, wherein the deformable walls are held at clamping sites in the housing.

14. (canceled)

15. An apparatus as claimed in claim 26, wherein the inert liquid is glycol.

16. (canceled)

17. An apparatus as claimed in claim 7, wherein the flat diaphragm is fixed substantially parallel to the conveying chamber on the housing in fastenings.

18. (canceled)

19. A process as claimed in claim 2, wherein the polymer is formed to at least 93% by weight from one or more of the monomers.

20-25. (canceled)

26. An apparatus as claimed in claim 7, wherein the cavity contains said inert liquid.

27. An apparatus comprising as structural components,
devices for storing and adding materials used and formed in a process for preparing polymer dispersions of at least one of the polymerizable monomers from the groups consisting of alkyl (meth)acrylates, vinyl esters of carboxylic acids having 1-20 carbon atoms, vinylaromatic compounds, nitrites, vinyl halides, vinyl ethers, hydrocarbons having 2-8 carbon atoms and one or two olefinic double bonds, and hydroxyl-containing monomers in emulsion polymerization technology at a polymerization temperature of at least 40° C., in the presence of a free-radical polymerization initiator,
a reaction vessel for carrying out said emulsion polymerization, said vessel having a jacket adapted for heating or cooling,
devices for emptying the reaction vessel,
an external cooling circuit which leads from and back to the reaction vessel and which comprises an extremely low-shear-conveying, cylinder or tubular, diaphragm pump and at least one heat exchanger, and
connecting lines between, from and to structural components of the apparatus,
wherein the extremely low-shear-conveying, cylinder or tubular, diaphragm pump comprises:
a conveying chamber adapted for conveying materials used and formed in said process, said chamber being bounded by deformable walls, and wherein parts in contact with said materials are provided with a friction-reducing coating or are composed of a friction-reducing material;
a cavity bounded by the opposite surface of said deformable walls and the inner surface of a housing, and adaptable to accommodate an inert liquid which is pressurizable and relievable from pressure by a flat diaphragm;
said flat diaphragm comprising an inner wall and an outer wall, said flat diaphragm being activatible by means of a drive, said flat diaphragm adapted to be acted upon by a pressure medium on its inner wall, and the outer wall of said flat diaphragm bounding a pressure chamber.
